(19) United States
(12) Patent Application Publication
(10) Pub. No.: US 2017/0150736 A1
(43) Pub. Date: Jun. 1, 2017

(54) SORBITOL POWDER COMPOSITION AND CHEWING GUM COMPRISING SAID COMPOSITION

(71) Applicant: SYRAL BELGIUM NV, Aalst (BE)

(72) Inventors: Abdelfattah BENSOUISSI, Aalst (BE); Nadia CAMUEL, Aalst (BE)

(21) Appl. No.: 15/316,434

(22) PCT Filed: Jun. 5, 2015
(86) PCT No.: PCT/IB2015/054259

§ 371 Date: Dec. 5, 2016

(30) Foreign Application Priority Data
Jun. 5, 2014 (BE) BE-2014/0431

(51) Int. Cl. A23G 4/08; A23L 29/30; A23P 10/20; A23L 27/30

(52) U.S. Cl. CPC A23G 4/08; A23L 27/34; A23L 29/37; A23P 10/20

(57) ABSTRACT

A pulverulent sorbitol composition of low friability or of high mechanical strength that is particularly suited to being manipulated under high shear or shock conditions, and the process for obtaining such a pulverulent composition. A chewing gum comprising such a pulverulent composition and the method for obtaining such a chewing gum.

The present invention relates to a pulverulent sorbitol composition of low friability or of high mechanical strength that is particularly suited to being manipulated under high shear or shock conditions, and also to the process for obtaining such a pulverulent composition. The invention also relates to a chewing gum comprising such a pulverulent composition and also to the method for obtaining such a chewing gum.

Sorbitol is widely used in the food industry. It has been found that during the handling of sorbitol, the properties of the powder could be modified. Specifically, the exertion of stresses or impacts on the particles may lead to their erosion or destructuring and thus induce a substantial creation of fine particles. This undesirable supply of fine particles modifies both the intrinsic properties of the powder (finer particle size, higher density, higher surface area, etc.), the behavior of the powder during its handling (poor flow, blockage of pipes during pneumatic transportation, packing in the silos and hoppers, etc.) and its storage (faster water uptake, setting to a solid, etc.).

Such degradation of the powders may be observed especially when they are conveyed by pneumatic transportation which may reach a speed of 40 m/s, or when they are introduced into silos or hoppers. Now, these steps are essential and may be repeated several times along a manufacturing line. Such a change in the powder is not desired since, firstly, it increases the risk of clogging or blocking of the pipes, of explosion, but also since the powder that is finally used no longer corresponds to the desired powder and thus reduces the production efficiency of the production lines.

More particularly, certain processes such as those relating to the production of chewing gums require the use of a pulverulent composition with a very specific particle size distribution. Thus, the use of a pulverulent composition that withstands high shears ensures that the composition finally incorporated into the process for obtaining the chewing gum effectively corresponds to the desired composition.

The properties of a sorbitol powder are associated both with the composition of the syrup used to produce it (purity and type of impurities) and with the crystallization method used to obtain it. Various crystallization techniques that are well known to those skilled in the art exist (Land. V., (2005). Industrial crystallization of melts, c. M., Van't Land Processing Enschede the Netherlands). The composition of the sorbitol syrup and the crystallization method used give the pulverulent composition its physicochemical properties and especially a certain level of mechanical stability, specific surface area and density. Among the crystallization methods that are the most advantageous in the context of the invention, examples that may be mentioned include extrusion, pan agglomeration, granulation or atomization described especially in the prior art (EP 1 008 602, GB 1 481 846 (Roquette Frères), EP 1 413 567 (DHW Deutsche Hydrierwerke GmbH).

In order to obtain a sorbitol-rich pulverulent composition of improved stability, which may be used in processes with very high shear or in pneumatic transportation, the present invention relates to a pulverulent composition containing at least 96% of sorbitol/DS, a sorbitol/(mannitol+arabitol) (w/w) ratio A of between 105 and 150 and/or a mechanical stability index D(v,0.1) of less than 60%, a bulk density of from 630 to 700 g/l and preferentially a specific surface area of between 0.6 and 1.8 m²/g.

The “sorbitol content” of the composition is measured on a dry weight basis. Preferentially, the pulverulent composition comprises a sorbitol content of greater than 96% (w/w) by dry weight, preferentially greater than 96.5%; 97%; 97.5%, 97.8%; 98%; 98.2% or 98.5%. More preferentially, the sorbitol content is between 96 and 99.3%; more preferentially between 96.5 and 99.2% or 97.4% and 99% or 97.6 and 98.8%. Typically, the sorbitol content is between 98% and 98.5%. For example, the sorbitol content may be about 98.2%. The inventors have demonstrated that below 96%/DS purity, the sorbitol syrup becomes difficult to crystallize and does not make it possible to obtain the pulverulent composition according to the invention.

The term “ratio A” or “sorbitol/(mannitol+arabitol) ratio” according to the invention means the ratio between the concentration (w/w) (or content) of sorbitol in the pulverulent composition and the sum of the concentrations of arabitol and mannitol. Preferentially, the pulverulent composition according to the invention comprises a sorbitol/(mannitol+arabitol) ratio A of between 105 and 150, preferentially from 110 to 149, more preferentially from 115 to 148, even more preferentially from 116 to 147, 117 to 146, 118 to 145, 120 to 144, 121 to 143, 122 to 142, 122.2 to 141 or from 121 to 130. Such a ratio makes it possible to modify the crystallization so that the shape and organization of the particles of the pulverulent composition, for example of the crystal agglomerates, give better resistance to mechanical impacts and also to shear forces.

Measurement of the concentration of these compounds is performed by HPLC, which is a technique well known to those skilled in the art, more particularly according to method ISO 10504:2013. This ratio indicates the proportion of the mixture of mannitol and arabitol in the sorbitol syrup. The inventors have found that this ratio gives the powder stability properties without having a negative impact on the sorbitol crystallization. Specifically, an excessively large amount of mannitol and/or arabitol in the sorbitol syrup is liable to greatly reduce the crystallization of the sorbitol and thus reduce the quality of powder obtained. Conversely, a reduced amount of mannitol and/or arabitol leads to the production of a powder with lower resistance to mechanical impacts.

According to the present invention, the term “specific surface area” means the measurement described in the European Pharmacopoeia 6.0 N°01/2008:20926, page 306 and in the article “BET Surface Area by Nitrogen Absorption” by S. Brunauer et al. (Journal of American Chemical Society, 60, 309, 1938). The BET specific surface area may be determined with a specific surface area analyzer of Micrometrics type based on a test of nitrogen absorption on the surface of the product subjected to the analysis. During the SSA measurement, the samples undergo a preliminary step of degassing under vacuum at 42° C. for 32 hours. Preferentially, the pulverulent composition according to the invention comprises a specific surface area of between 0.6 and 1.8 m²/g, preferentially between 0.65 and 1.5; 0.68 and 1.4; 0.7 and 1.35; 0.75 and 1.3; 0.8 and 1.25; and more preferentially between 0.82 and 1.2 m²/g.

The specific surface area of a pulverulent composition reflects both the outer surface area of the particles and the surface area of the pores within the particles. Thus, for a given mass of powder, the finer and more porous the particles, the higher the specific surface area. Conversely, the denser the particles, the lower the specific surface area. Thus, the low specific surface area of the pulverulent composition according to the invention also makes it possible to increase the resistance of the particles of the composition to impacts.

The term “bulk density” means the density as measured according to the method described in the European Pharmacopoeia 6.0 N°01/2008:20915, page 285. More particularly, the bulk density measurement is taken using a machine of Erweka type (Erweka GmbH). The bulk density may be measured, for example, by introducing a certain mass of pulverulent composition into a glass measuring cylinder (volume=250 ml) until a volume of powder equal to 250 ml is obtained. The pulverulent composition is introduced such that no compacting is obtained during filling. To do this, the filling is performed gradually using a spatula and a funnel held 6 cm from the upper limit of the measuring cylinder. The bulk density is then deduced from the difference in mass of the measuring cylinder before and after filling according to the following formula: Bulk density (g/l)=((mass of the measuring cylinder+sample)−(mass of the empty measuring cylinder))×4.

Preferentially, the pulverulent composition according to the invention has a bulk density of from 630 to 700 (g/l), preferentially from 640 to 690; 650 to 680 or from 655 to 675 g/l.

The bulk density generally depends essentially on the morphology of the crystals, the state of arrangement of the crystals in the particles (porosity) but also the state of spatial arrangement of the particles (cohesion), the particles being formed from crystal agglomerates. All these properties depend on the implementation parameters of the sorbitol crystallization and more precisely on the quality of the syrup used to produce the pulverulent composition (purity and type of impurities).

The term “tapped density” means the measurement of the density after tapping a powder as described in the European Pharmacopoeia 6.0 N° 01/2008:20915, page 285. Typically, measurement of the tapped density may be performed in the same manner as the bulk density, but the reading of the volume is taken in the measuring cylinder after 500 consecutive taps applied to the powder. The tapped density may be calculated according to the following formula: Tapped density (g/l)=((mass of the measuring cylinder (g)+sample (g))−(mass of the empty measuring cylinder(g)))×1000/Volume occupied by the powder after tapping expressed in milliliters. The composition according to the invention has a tapped density of from 650 to 730 (g/l), 660 to 725; 670 to 720; 675 to 710 or 680 to 705 g/1.

The tapped density generally reflects the change in spatial arrangement of the particles of the pulverulent composition when it is subjected to a tapping constraint. Thus, it reflects the resistance of the crystals to the force exerted by their own weight conjugated with the pressure exerted. This resistance depends on the cohesion and morphology of the crystals.

The tapped density and the bulk density depend on the crystallization of the sorbitol and more precisely on the quality of the syrup used to produce the pulverulent composition (purity and type of impurities).

The pulverulent composition according to the invention has a mean particle size (described by the D(v,0.5)) of from 100 to 400 microns, preferentially between 150 and 380 microns, more preferentially between 120 and 360 microns; typically, the mean particle size of the pulverulent composition is between 150 and 350 microns or between 180 and 220 microns.

Typically, the pulverulent composition according to the invention is composed of crystal agglomerates preferentially obtained by crystallization and granulation, especially by extrusion, pan agglomeration, continuous granulation or atomization.

Measurement of the mean particle size is preferentially performed by screening according to methods such as the Alipine and/or Retsch methods.

Advantageously, the pulverulent composition according to the invention has a particle size distribution as follows:
from 0 to 2.3% by weight of particles >400 microns, preferentially of particles between 400 and 600 microns,
from 34.8% to 54.9% by weight of particles between 250 and 400 microns,
from 42.7% to 57.9% by weight of particles between 100 and 250 microns,
from 1.4% to 8.0% by weight of particles between 75 and 100 microns, and
from 0.5 to 4.8% by weight of particles <75 microns, the sum of the various fractions of which being 100% by weight.

These particle size distribution properties combined with the resistance property of the powder to shear make these powders most particularly suitable for application in the manufacture of chewing gum.

Preferentially, the pulverulent composition according to the invention has a particle size distribution as follows:
from 0 to 1% by weight of particles >400 microns, preferentially of particles between 400 and 600 microns,
from 40% to 45% by weight of particles between 250 and 400 microns,
from 48% to 53% by weight of particles between 100 and 250 microns,
from 3.5% to 8% by weight of particles between 75 and 100 microns, and
from 0 to 2.5% preferentially of 0.5% to 2.5% by weight of particles <75 microns, the sum of the various fractions of which being 100% by weight.

Analysis of the particle size distribution may be performed by various techniques such as the Alipine and/or Retsch techniques.

Measurement of the particle size distribution is preferentially performed via the Retsch method according to the method described in the European Pharmacopoeia 6.0 N°01/2008:20938, page 325.

More particularly, the particle size distribution of the powder according to the invention may be measured using a Retsch model AS200 control ‘g’ sieve shaker according to the manufacturer's recommendations. The use of this Retsch equipment for performing these analyses is well documented by the manufacturer and in the literature.

Typically, the sorbitol powders may be characterized in the following manner: 100 g of each of the powders is supplemented with 1 g of free-flowing agent such as silica (Sipernat® 22 S). The homogenized mass is screened by said equipment with an oscillation amplitude of 1.5 mm for 10 minutes. The various screens used (400, 250, 100 and 75 microns) according to this method are certified (ISO 3310-1). Each screen is then weighed so as to measure the weight of each of the particle size fractions and to calculate a particle size distribution as percentages. For the weighing of the various screens before and after screening, a precision balance (0.1 g) is used.

The particle size distribution has a direct influence on the flow of the pulverulent composition. In general, a high content of fines is unfavorable to the flow of the pulverulent composition due to the fact that the fines intercalate between the coarse particles and constitute bridges that oppose the sliding of the coarse particles.

The pulverulent composition according to the invention has very good mechanical stability. According to the present invention, the mechanical stability is evaluated by an index known as the “Mechanical Stability Index (MSI)”. This index, expressed as a %, represents the variation in D(v,0.1) when the pulverulent sorbitol composition is subjected to an impact test.

The term “D(v,0.1)” means the maximum diameter of the fine particles occupying 10% of the total volume of the powder.

The term “MSI” or “MSI_{D(v,0.1)}” means the fraction calculated as follows:

$$M S I = \frac{( D ( v , 0.1 ) a - D ( v , 0.1 ) b ) \times 100}{D ( v , 0.1 ) a}$$

in which D(v,0.1)b corresponds to the D(v,0.1) of said pulverulent composition measured after an impact test comprising three cycles of projection of said pulverulent composition at 20 m/sec onto a non-deformable smooth surface, and D(v,0.1)a corresponds to the D(v,0.1) of said pulverulent composition measured before the impact test.

The MSI reflects the degree of particle breakage following the impact test. Thus, the higher the MSI, the more mechanically fragile the powder.

The fractions corresponding to the degree of breakage of particles of the fraction of the particles corresponding to the D(v,0.5) and the D(v,0.9) may also be measured, but are less representative of the properties of the powder than that calculated as a function of the D(v,0.1).

The choice of D(v,0.1) to calculate the MSI is particularly pertinent insofar as it reflects the fine fraction of the pulverulent composition. This fraction of the pulverulent composition represents the fraction that is the most greatly affected during the cleavage of the particles in the impact test. Thus, during cleavage of the particles, the proportion of finest particles varies (and especially increases) more greatly than the other fractions of the pulverulent composition (when, themselves, decrease), the coarsest particles breaking into two or more fine particles. Furthermore, the increase in the representativity of the fine fraction of the pulverulent composition induces changes in the properties of the powder (density, specific surface area, flow), but also numerous problems such as the setting to a solid of the composition during storage, the rapid water uptake, the increased risk of explosion, the appreciable losses of material in the workshop, the risk of inhalation by the operators, etc. Typically, the pulverulent composition according to the invention has an MSI D(v,0.1) of less than 60%, preferentially less than 58%, 56%, 55%, 53% 52%, 50%. Preferentially, the pulverulent composition according to the invention has an MSI of between 60% and 20%, preferentially between 55% and 25%; 53% and 30%; 52% and 35%; 50% and 40%.

As a guide, the calculation of the stability of a powder evaluated from the D(v,0.5) (MSI_{D(v,0.5)}) or from the D(v,0.9) (MSI_{D(v,0.9)}) may be performed from the cumulative particle size distributions according to the same approach as that used to evaluate the MSI_{D(v,0.1)}.

$$M S {I}_{D ( v , 0.5 )} = \frac{( D ( v , 0.5 ) a - D ( v , 0.5 ) b ) \times 100}{D ( v , 0.5 ) a}$$

With

D(v,0.5)a corresponding to the D(v,0.5) before the impact test and

D(v,0.5)b corresponding to the D(v,0.5) after the impact test.

$$M S {I}_{D ( v , 0.9 )} = \frac{( D ( v , 0.9 ) a - D ( v , 0.9 ) b ) \times 100}{D ( v , 0.9 ) a}$$

With

D(v,0.9)a corresponding to the D(v,0.9) before the impact test and

D(v,0.9)b corresponding to the D(v,0.9) after the impact test.

Thus, such a calculation for the composition according to the invention makes it possible to obtain MSI_{D(v,0.5)} values of less than 20%, preferentially less than 18%; 17.5%; 16% or 16.5%. Preferentially, the pulverulent composition according to the invention has an MSI_{D(v,0.5)} of between 20% and 5%, preferentially between 18% and 7%; 17.5% and 8%; 16% and 9%; or between 16.5% and 10%. The pulverulent composition according to the invention has an MSI_{D(v,0.9)} of less than 13%, preferentially less than 12.5%; 12%; 11.9% or 11.8%. Preferentially, the pulverulent composition according to the invention has an MSI_{D(v,0.9)} of between 13% and 5%, preferentially between 12.5% and 5%; 12% and 6%; 11.9% and 6.5%; or between 11.8% and 7%.

Advantageously, the composition according to the invention has an MSI_{D(v,0.1)} of less than 60% and an MSI_{D(v,0.9)} of less than 13% or an MSI_{D(v,0.1)} of less than 60%, and an MSI_{D(v,0.9)} of less than 12.5%, or an MSI_{D(v,0.1)} of less than 56%, and an MSI_{D(v,0.9)} of less than 13%, or an MSI_{D(v,0.1)} of less than 55%, and an MSI_{D(v,0.9)} of less than 12%, or an MSI_{D(v,0.1)} of less than 60%, an MSI_{D(v,0.5)} of less than 20% and an MSI_{D(v,0.9)} of less than 13%, or an MSI_{D(v,0.1)} of less than 58%, an MSI_{D(v,0.5)} of less than 18% and an MSI_{D(v,0.9)} of less than 13%, or an MSI_{D(v,0.1)} of less than 55%, an MSI_{D(v,0.5)} of less than 18% and an MSI_{D(v,0.9)} of less than 13%, or an MSI_{D(v,0.1)} of less than 55%, an MSI_{D(v,0.5)} of less than 17% and an MSI_{D(v,0.9)} of less than 13%.

Advantageously, the composition according to the invention has an MSI_{D(v,0.1)} of between 60% and 20%, an MSI_{D(v,0.9)} of between 13% and 5% or an MSI_{D(v,0.1)} of between 60% and 20%, and an MSI_{D(v,0.9)} of between 12.5% and 5%, or an MSI_{D(v,0.1)} of less than 56%, and an MSI_{D(v,0.9)} of between 13% and 5%, or an MSI_{D(v,0.1)} of less than 55%, and an MSI_{D(v,0.9)} of between 12% and 6%, or an MSI_{D(v,0.1)} of between 60% and 20%, an MSI_{D(v,0.5)} of between 20% and 5% and an MSI_{D(v,0.9)} of between 13% and 5%, or an MSI_{D(v,0.1)} of between 58% and 20%, an MSI_{D(v,0.5)} of between 18% and 7% and an MSI_{D(v,0.9)} of between 13% and 5% or an MSI_{D(v,0.1)} of between 55% and 20%, an MSI_{D(v,0.5)} of between 18% and 7% and an MSI_{D(v,0.9)} of between 13% and 5%, or an MSI_{D(v,0.1)} of between 55% and 20%, an MSI_{D(v,0.5)} of between 17.5% and 7% and an MSI_{D(v,0.9)} of between 13% and 5%.

Nevertheless, the MSI_{D(v,0.1)} values are preferred in that they are more representative of the stability of a pulverulent composition.

The prior art describes various methods for measuring the friability of a powder which are not pertinent for characterizing the stability of the powder during its handling. By way of example, patent EP 0 645 096 describes a method for measuring the friability of pulverulent sorbitol compositions, which consists in placing a given mass of powder in the presence of metal beads in a rotating drum. The pulverulent composition obtained is then screened on a 100 μm screen and the weight proportion represented by the retained residue is determined. However, the metal beads exert compression forces on the particles of the composition that are not generally observed in handling or during the transfer of powders, but are found in ball mills. Such methods are described in the prior art as being less severe for powders of fine particle sizes (U.S. Pat. No. 5,573,777), and they therefore do not appear to be suitable for the analysis of powder with a broad particle size spectrum.

The impact test is particularly pertinent in the evaluation of the mechanical stability of a powder in that it is very representative of the forces exerted on the particles of the pulverulent composition during its handling in general and more particularly during industrial pneumatic transportation which is very widely used or during the loading of pulverulent compositions into silos or the like. Typically, according to the present invention, the term “impact test” means a test of three cycles of projection of the pulverulent composition according to the invention at 20 m/sec onto a non-deformable smooth surface.

The impact test is performed by projecting the pulverulent composition using an air jet onto a target; three impact cycles are preferably performed. The impact speed, the inclination of the target and the powder feed rate are modulable according to the operator's wishes. Preferentially, the projection speed of the pulverulent composition is 20 msec.

Such an impact test is known to those skilled in the art, and the schematic diagram of this machine is especially described in the article “Use of wet granulation powders: bases and theory” by S. Khashayar and P. Guigon (Techniques de l'Ingénieur Opérations Unitaires Tri et Traitement des Liquides et des Solides [Engineering techniques unit operations: Sorting and treatment of liquids and solids], article ref: j2253, 2014), URL=http://www.techniques-ingenieur.fr/base-documentaire/procedes-chimie-bio-agro-th2/operations-unitaires-tri-et-traitement-des-liquides-et-des-solides-42446210/mise-en-uvre-des-poudres-j2253/.

As a guide, the facility comprises:
a unit for continuously feeding powder (vibrating hopper equipped with a system of mass monitoring over time),
a pneumatic circuit for acceleration and projection onto the target. Such a circuit is known to those skilled in the art. By way of example, a circuit suitable for accelerating and transporting the pulverulent composition according to the invention to a target is described in the article “Experimental Investigations on Single Plate Fluid Energy Milling” by K. Lechsonski and U. Menzel (Proceedings of First World Conference on Particles Technology, Vol 2, 1988, 297-323). As a guide, tubes with an inside diameter of 0.6 cm may be used for transporting the particles to the nozzle. The feed rate and the projection speed may be variable and controlled by computer. As a guide, a suitable feed rate of pulverulent sorbitol may be 1 g/sec. Typically, a suitable projection speed is, for example, 20 msec.
an impact chamber equipped with a target. The shape and size characteristics of the impact chamber may be readily adapted by a person skilled in the art. For example, a chamber 15×15×15 cm in size is particularly suitable. The distance travelled by the particles between the acceleration nozzle and the target may be modified as a function of the desired impact speed. Typically, a distance of one meter allows the impact test to be performed. The target may be of inclinable type, so as to allow an inclination of 45°, for example. As a guide, a target that is suitable for the present test is a target made of a non-deformable material such as a polymer or a metal. For example, the target may be made of iron, aluminum or steel such as a polished steel. The shape and size properties of the target may be readily obtained by a person skilled in the art. The target may be of any shape, for example circular and of a size sufficient to allow projection of the pulverulent powder. Typically, a target 6 cm in diameter allows the impact test to be performed.
a solid/gas separation system may be provided, for instance by using a filter.

The pulverulent composition is recovered after impact, for analysis.

Preferentially, several impact cycles may be performed. Typically, three impact cycles are performed.

The particle analysis after the impact test may be performed using laser particle size analysis, in accordance with the method described in the European Pharmacopoeia 6.0 N°01/2008:20931, page 311. For example using a Mastersizer machine (model: Meyvis MZ63). In order to have the most reliable results possible, prior dispersion of the powder in a suitable solvent that does not cause either dissolution or agglomeration of the particles is recommended. By way of example, a sunflower oil not containing any trace of water may be used.

The invention also relates to a process for preparing a pulverulent composition, comprising:
a step of crystallizing a sorbitol syrup comprising a sorbitol/(mannitol+arabitol) ratio A of between 105 and 150, preferentially 110 and 149 or 110 and 145
a step of wet granulation of the powder obtained using a binder; preferentially, the binder is a sorbitol syrup, preferentially a sorbitol syrup comprising a sorbitol/(mannitol+arabitol) ratio A of between 105 and 150, preferentially 110 and 149 or 110 and 145 and
a step of maturation, by drying, of the granulated composition thus obtained,
optionally, a step of cooling of the granulated composition obtained, preferentially at a temperature below 10° C., preferentially between 10 and −10° C., more preferentially between 8 and −8° C., typically between 5 and −5° C.

Typically, the crystallization and granulation steps are performed simultaneously, preferentially by atomization, extrusion, granulation or pan agglomeration. For example, the crystallization and/or granulation steps are performed in a continuous mixer-granulator, an atomization tower, an extruder or an open rotating container (known as a pan).

Advantageously, the crystallization and/or granulation steps are performed by spraying a binder that may be water or a sorbitol syrup with a ratio A of between 105 and 150 onto a pulverulent sorbitol composition in motion. Said pulverulent sorbitol composition is placed in motion by stirring or in a stream of air. Typically, said sorbitol syrup has a solids content of between 65 and 99.9%, preferentially between 70 and 99.8%, typically between 99.5 and 99.8%. Preferentially, said pulverulent composition also has a ratio A of between 105 and 150. The pulverulent sorbitol composition is used as initiator for the crystallization at the start of the process, and the crystals obtained are then granulated during and at the end of the process.

According to one embodiment, the crystallization and granulation steps are performed inside an open rotating container, with a rotational axis optionally inclined from 25 to 60° relative to the horizontal. Advantageously, the rotation speed of the container is from 5 to 30 revolutions per minute (rpm). Typically, said sorbitol syrup is sprayed onto a bed of sorbitol powder placed in motion via the rotation of the container. Said syrup has a solids content of greater than 90%, preferentially greater than 99%, typically between 99.5 and 99.8%. The temperature is maintained between 90° C. and 95° C. in the container. The sorbitol syrup/pulverulent composition ratio (mass/mass) is about 1/1 to 1/30.

According to another embodiment, the crystallization and/or granulation steps are performed in a continuous mixer-granulator. Typically, the mixer-granulator is equipped with an axle and knives arranged as paddles and a system for spraying liquids via injection nozzles. As a guide, such mixer-granulators are, for example, of vertical Flexomix type sold by Hosokawa Schugi, or of horizontal CB type sold by Lödige or of Turbocrystallizer type sold by Vomm Impianti e Processi S.R.L. The pulverulent sorbitol composition and the sorbitol syrup are introduced continuously and the granulated composition obtained is discharged continuously preferentially onto a drier for the maturation step. Typically, the mixer-granulator is fed with a stream of pulverulent sorbitol composition and of sorbitol syrup with a sorbitol syrup/pulverulent composition ratio (mass/mass) of 1/3 to 2/1, preferentially 1/1.5 to 1/1. In addition, the sorbitol syrup has a solids content of from 97% to 99.9%, typically between 99.5% and 99.8%. Advantageously, the sorbitol syrup is sprayed at a temperature of 110° C. The blade shaft of the granulator is driven in rotation at a speed of from 400 to 3000 revolutions per minute, about 700 rpm to 1500 rpm. The inner wall is thermostatically regulated at a temperature of between −15° C. and 5° C. With a mean residence time of 30 seconds, the granulated crystalline sorbitol is removed continuously at a temperature of about 55° C.

According to another embodiment, the crystallization and granulation steps are performed in an atomization tower, for example a tower of MSD (multi-stage dryer) type. Typically, the sorbitol powder is introduced into the tower and a sorbitol syrup with 65% to 80% solids is sprayed onto the sorbitol powder. The sorbitol syrup/pulverulent composition ratio (mass/mass) is about 1/1 to 1/4. For example, the tower is fed with a flow rate of sorbitol syrup of the order of 300 kg/h and with sorbitol powder at a flow rate of between 350 and 800 kg/h.

Depending on the atomization tower chosen, a person skilled in the art will be capable of determining the temperatures according to the air streams. Typically, the temperature of the air fed into the tower is between 100 and 150° C., and the temperature of the static bed has a value of between 60 and 80° C.

According to another embodiment, the crystallization and granulation steps are performed by extrusion. Typically, the crystallization and granulation steps are performed in an extruder comprising several sheaths equipped with cooling systems and delimiting three zones. Sorbitol syrup is introduced into the first zone and is maintained at a temperature preferentially above 80° C., typically between 85-95 C. Advantageously, the pulverulent composition is introduced into the second zone, and the mixture is preferentially maintained at a temperature of between 75 and 90° C. In the third zone, the temperature of the mixture is preferentially reduced to a temperature of about 70 to 80° C. up to the extrusion nozzle.

The extruder screw is preferably maintained at 40-60 rpm. The extruder is preferably a twin-screw extruder. Typically, the flow rate of the sorbitol syrup is preferably 20-40 kg/h, and the residence time of the sorbitol syrup is about 1 to 2 minutes.

Advantageously, said sorbitol solution contains 85% to 99.9% solids, preferentially 95% to 98% solids. The sorbitol syrup/pulverulent sorbitol composition proportion is from 2/1 to 1/1.

According to the process of the invention, the maturation step comprises placing in motion the granules obtained at a temperature of between 50 and 90° C. for 0.5 to 7 hours, typically between 3 and 5 hours. For example, the maturation step may be reduced to less than one hour in the case of extrusion or to about 2 to 4 hours in the case of atomization, continuous granulation or pan agglomeration.

The maturation step is directed toward reducing the moisture content of the product and inducing recrystallization of the unstable sorbitol polymorphs into stable polymorphs.

Typically, the process according to the invention comprises a milling and/or screening step. Milling and screening processes are well known to those skilled in the art. Typically, the screening step is preferentially performed successively on screens of 800 and 400 microns, preferentially screens of continuous industrial type. Such screens are known to those skilled in the art. Optionally, the particles retained on the screens are milled again and then screened so as to obtain the particle size distribution according to the invention. Typically, the mill used may be a paddle mill, hammer mill or pin mill. The screens used may be centrifugal or vibrating screens. The process according to the invention optionally comprises a step of removing the fine particles preferentially by de-fining, with a fluidized bed and/or by classification (zig-zag classifier or classifier of Ventoplex® type sold by Hosokawa Alpine).

The step of cooling of the pulverulent composition is particularly advantageous in that it facilitates the milling by preventing fouling of the mill and the use of excessive milling stresses which may give rise to considerable amounts of fine particles and consequently to fouling of the workshop. This cooling step is particularly advantageous for obtaining, after milling and screening, a powder having the particle size distribution according to the invention. Typically, such a cooling step is performed with a cooler, for example a vertical vibrating-plate cooler suitable for bulk solid materials; such coolers are known to those skilled in the art. Advantageously, the milling, de-fining and screening steps are performed with air having an absolute moisture content of between 3 and 5 g of moisture per kg of air.

The invention also relates to a chewing gum comprising 2% to 85% (w/w) of the pulverulent composition according to the invention.

The term “chewing gum” means a composition comprising a part that is insoluble in water or saliva made of base gum and a soluble part comprising at least one polyol or a mixture of polyols including the pulverulent composition according to the invention. More particularly, the term “chewing gum” means a composition comprising a base gum, a filler such as a sweetener or a polyol (or sugar alcohol), for example, chosen from sorbitol, maltitol, xylitol or a mixture thereof, at least one plasticizer chosen especially from a polyol syrup, glycerol, lecithin or a mixture thereof, and at least one flavoring. Preferentially, the chewing gum comprises a base gum and the pulverulent composition according to the invention.

Various formulations of chewing gums and the method for obtaining them are widely described in the prior art and especially in “Formulation and Production of Chewing and Bubble Gum” by Fritz, Douglas, page 142. In general, chewing gums are obtained by sequential addition of the various ingredients of the chewing gum (˜15-20 minutes) in a commercial blender well known to those skilled in the art, for example a jacketed blender allowing fine control of the temperature so as to enable softening of the base gum and regulation of the temperature of the chewing gum mass, for example at 50° C. during the process for obtaining the chewing gum.

More particularly, the term “chewing gum composition” means a composition comprising a base gum and optionally a filler such as a sweetener or a polyol (or sugar alcohol) chosen from sorbitol, maltitol, xylitol, lactitol, erythritol, isomalt or a mixture thereof, at least one plasticizer chosen especially from a polyol syrup, glycerol, lecithin or a mixture thereof, and at least one flavoring. The chewing gum may also comprise an intense sweetener chosen especially from aspartame, acesulfame, thaumatine, saccharin or cyclamate.

The term “filler” means a sweetener such as D-glucose, sucrose, sucralose or a polyol, preferentially a mixture of polyols such as sorbitol and xylitol, sorbitol and mannitol or sorbitol and mannitol.

Preferentially, the chewing gum is sugar-free.

The invention also relates to a method for producing a chewing gum, comprising the following steps consisting in
obtaining a base gum,
mixing the base gum with a pulverulent composition according to the invention,
optionally, adding any one of the components chosen from a plasticizer, a filler, a flavoring and a mixture thereof.

The invention also relates to the chewing gum obtained directly by performing this process.

Although having different meanings, the terms “comprising”, “containing”, “including” and “consisting of” have been used interchangeably in the description of the invention, and one may be replaced by the other.

Other properties, aspects, subjects and advantages of the present invention will emerge even more clearly on reading the description and the examples that follow.

### EXAMPLE 1: PRODUCTION OF THE POWDERS AND CHEMICAL COMPOSITION

Sorbitol solutions are obtained by hydrogenation of dextrose syrups comprising more than 99% dextrose, from 0.1% to 0.4% fructose and from 0.3% to 0.5% disaccharides. The hydrogenation is performed batchwise according to the conditions described in the reference Roland Albert et al., Chem Ing Tech 52 (1980) No 7 page 582-587. The reaction is stopped when the degree of conversion reaches 99.8%.

The syrups obtained by hydrogenation are analyzed by HPLC in order to determine their composition according to the method ISO 10504:2013. The HPLC analysis is conducted using solutions diluted to 10% by mass per mass of solution according to the following conditions:
Eluent: degassed purified water filtered through a 0.22 μm membrane
Column: Ca++ form, type HPX, 87C (Biorad cat. No. 125-0095)
Detector: differential refractometry
Separation temperature: 80-85° C.
Injected volume: 10 μl
Elution rate: 0.5 ml/min.

The HPLC (Shimadzu) is precalibrated according to the manufacturer's recommendations with standard solutions of very high purity (Sigma Aldrich). Calculation of the concentration by the use of HPLC is performed according to the method ISO 10504:2013. More specifically, this calculation of the concentration of each compound takes into account the correction factors specific to the various compounds present in the sample and also the surface area of each peak present in the chromatogram.

$$The concentration of various {compounds }^{``} {i}^{ ″} expressed in ( \% ) = \frac{KFi \times {area}_{i} \times 100}{{\sum }_{i = 1}^{n} ( KFi \times {area}_{i} )}$$

with: KFi=correction factor for each compound i
Areai=surface area of the peak corresponding to compound i.

Once the various measurements have been taken, the sorbitol/(mannitol+arabitol) ratio is calculated for each sorbitol syrup obtained. In order to determine the effect of the sorbitol/(mannitol+arabitol) ratio on the powder obtained, various syrups having solids contents of about 70% and comprising different sorbitol/(mannitol+arabitol) ratios are prepared:
Solution 1 (Sol 1): R_{Sol 1}=129.1
Solution 2 (Sol 2): R_{Sol 2}=122.7
Solution 3 (Sol 3): R_{Sol 3}=140.3.

The pulverulent compositions having different sorbitol/(mannitol+arabitol) ratios (R) were obtained by pan agglomeration as described in patent application GB 1 481 846 (Roquette Frères SA). More particularly, the solutions Sol 1, Sol 2 and Sol 3 were introduced into an evaporation facility. When the required amount of sorbitol solution is introduced into the facility, the temperature is gradually increased to 125° C. and the pressure is reduced below 20 mm of mercury. After evaporation for two hours, molten sorbitol with a solids content of 99.8% is obtained. The molten sorbitol is then placed in a storage tank before being pumped and sprayed in the form of globules with diameters of less than 0.1 mm by means of a suitable spraying nozzle (diameter=0.4 mm) in a rotating inclined cylindrical chamber known as a rotating “pan” or drum (diameter=3.6 m; height=1.2 m, inclination=30° relative to the horizontal). The pressure used for pumping the molten sorbitol up to the nozzle is equal to 3.5 kg/cm². Simultaneously with this dispersion of the molten sorbitol, an equivalent amount of crystalline sorbitol is provided. The pan rotates at a speed of 7 revolutions per minute, and this makes it possible to obtain granules with a diameter equal to 4 mm. The pan is equipped with a doctor blade to ensure better mixing of the sorbitol particles with the molten sorbitol glebules. The temperature in the pan is maintained at at least 90° C.

The mean time required for a particle or globule to integrate the 4 mm granules before leaving the pan is about 30 minutes. Thereafter, the 4 mm granules are introduced into a rotating inclined cylinder (diameter=1.8 m, length=8.5 m, inclination=5°, rotation speed=10 revolutions/min) and remain therein for about 5 hours at a temperature of between 90 and 95° C. This step is known as maturation and its purpose is to increase the crystallinity by promoting the recrystallization of the unstable forms of sorbitol into stable forms. This is ensured by keeping the granules in motion at temperatures of between 50 and 90° C. On leaving the maturation step, the granules are cooled to a temperature close to zero and then milled, screened and de-fined by means of a standard facility suitable for calibrating pulverulent food products.

The milling, de-fining and screening steps are performed with air having an absolute moisture content that is as low as possible (about 3 g of moisture per kg of air).

As a guide, solutions with sorbitol/(mannitol+arabitol) ratios of less than 50 were able to be obtained, if necessary, by adding mannitol and/or arabitol. Nevertheless, the latter gave rise to many problems of fouling in the pan due to the difficulty in crystallizing the molten sorbitol and consequently the impossibility of performing the agglomeration. This confirms that a high content of specific impurities such as mannitol and/or arabitol may inhibit the crystallization of the sorbitol. The inventors furthermore observed that adjustment of the mannitol-arabitol content in the composition so as to obtain sorbitol/(mannitol+arabitol) ratios of between 120 and 150 made it possible to considerably improve the stability of the process (fouling of the pan) and to obtain a powder having the properties described above.

The pulverulent sorbitol compositions obtained corresponding to solutions Sol 1, Sol 2 and Sol 3 are referred to hereinbelow, respectively, as PSC1, PSC2 and PSC3. The sorbitol/(mannitol+arabitol) ratios A corresponding to these compositions were determined by HPLC as stated previously (see table 1). As a guide, several commercial products are included in the same table.

TABLE 1
Sorbitol/(mannitol + arabitol) ratios
A of the various pulverulent compositions

| | | A: |
|---|---|---|
| | | Sorbitol/(mannitol + |
| Composition | Product name | arabitol) |
| PSC1 | Present invention: Product 1 | 129.1 |
| PSC2 | Present invention: Product 2 | 122.7 |
| PSC3 | Present invention: Product 3 | 140.3 |
| PSC4 | Neosorb P60 W (Roquette Frères) | 176.6 |
| PSC5 | Neosorb P60 W (Roquette Frères) | 157.0 |
| PSC6 | Neosorb P60 (Roquette Frères) | 154.5 |
| PSC7 | Neosorb P60 (Roquette Frères) | 170.5 |
| PSC8 | Sorbidex S16603 (Cargill) | 137.1 |
| PSC9 | Sorbidex S16603 (Cargill) | 141.2 |
| PSC10 | Sorbitol T (Ecogreen) | 153.5 |
| PSC11 | Sorbitol T (Ecogreen) | 330.6 |
| PSC12 | Parteck SI 150 (Merck) | 202.0 |

### EXAMPLE 2: PARTICLE SIZE DISTRIBUTION AND BULK DENSITY

The pulverulent sorbitol compositions PSC1 to PSC12 of example 1 were analyzed to determine their particle size distributions according to the Retsch method (table 2).

The Retsch method is performed in accordance with the method described in the European Pharmacopoeia 6.0 N°01/2008:20938, page 325. More particularly, the particle size is measured using a Retsch sieve shaker, model AS200 according to the manufacturer's instructions. 100 g of pulverulent sorbitol are weighed out and mixed gently with 1% to 2% of free-flowing agent such as Sipernat® 22 S. The mixture is then screened through a tower of screens stacked in leaktight manner on top of each other. The various screens used are certified (ISO 3310-1) and have, respectively, cutoff thresholds of 75, 100, 250, 400 and 600 μm. Screening is performed for 10 minutes with an amplitude of 1.5. For the weighing of the various screens before and after screening, a precision balance (0.1 g) is used. The measurements are thus taken to ±0.1.

TABLE 2
Particle size distributions of the various pulverulent compositions

| | <75 | 75-100 | 100-250 | 250-400 | 400-600 |
|---|---|---|---|---|---|
| Compositions | μm | μm | μm | μm | μm |
| PSC1 | 1.6 | 4.4 | 51.6 | 41.8 | 0.5 |
| PSC2 | 2.1 | 4.1 | 49.4 | 44.1 | 0.3 |
| PSC3 | 5 | 5.6 | 54.3 | 34.9 | 0.2 |
| PSC4 | 8.8 | 6.4 | 50.5 | 31.2 | 3.1 |
| PSC5 | 8.5 | 8.4 | 46.1 | 31.5 | 5.5 |
| PSC6 | 18.8 | 9.2 | 48.5 | 22.7 | 0.8 |
| PSC7 | 17.3 | 8.7 | 50.5 | 22.9 | 0.6 |
| PSC8 | 11.8 | 9.2 | 42 | 35.8 | 1.2 |
| PSC9 | 13.9 | 9.1 | 49 | 27.1 | 0.9 |
| PSC10 | 1.9 | 1.1 | 58.6 | 36.9 | 1.5 |
| PSC11 | 2.3 | 2.7 | 56 | 38 | 1 |
| PSC12 | 7.4 | 9.6 | 55 | 25 | 3 |

The pulverulent sorbitol compositions PSC1 to PSC12 were analyzed to determine their bulk density (table 3). The bulk density is measured according to the method described in the European Pharmacopoeia 6.0 N°01/2008:20915, page 285. More particularly, the bulk density of the pulverulent sorbitol composition is measured by means of a machine of Erweka type (Erweka GmbH SVM22). A volume of 250 ml of powder is gradually introduced using a spatula and a funnel held 6 cm from the upper limit of a glass measuring cylinder (volume=250 ml) so that no compacting is obtained during filling. The bulk density is then deduced from the difference in mass of the measuring cylinder before and after filling according to the following formula:

$$Bulk density ( g \text{/} l ) = [ ( mass of the measuring cylinder + sample ) - ( mass of the empty measuring cylinder ) ] \times 4$$

The tapped density is obtained by reading the volume of powder in the measuring cylinder after 500 consecutive taps (until the volume of powder becomes constant). It is calculated according to the following formula:

$$Tapped density ( g \text{/} l ) = \frac{[ \begin{matrix}( mass of the measuring cylinder + sample ) - \\ ( mass of the empty measuring cylinder ) \end{matrix} ] \times 1000}{Volume occupied by the powder after tapping}$$

TABLE 3
Bulk density of the various pulverulent compositions

| Pulverulent | Bulk density | Tapped density: 500 taps | |
|---|---|---|---|
| composition | (g/l) | (g/l) | Hausner index |
| PSC1 | 667 | 719 | 1.078 |
| PSC2 | 665 | 704 | 1.059 |
| PSC3 | 658 | 697 | 1.059 |
| PSC4 | 669 | 730 | 1.091 |
| PSC5 | 659 | 736 | 1.117 |
| PSC6 | 643 | 727 | 1.131 |
| PSC7 | 654 | 737 | 1.127 |
| PSC8 | 710 | 815 | 1.148 |
| PSC9 | 720 | 825 | 1.146 |
| PSC10 | 570 | 617 | 1.082 |
| PSC11 | 616 | 672 | 1.091 |
| PSC12 | 448 | 498 | 1.112 |

Table 3 shows that the pulverulent compositions PSC1, PSC2 and PSC3 manufactured in the context of this invention have the lowest Hausner indices and this is synonymous with better flowability.

Tables 2 and 3 show that, with the exception of compositions PSC10 and PSC11 (products having relatively low densities), the pulverulent compositions PSC1, PSC2 and PSC3 have both the lowest Hausner ratios and the lowest contents of fine particles (particles <75 μm). The latter properties are particularly advantageous in that they confirm very good flowability of the powder, making it particularly suitable for pneumatic transportation. Specifically, a powder having such properties allows feeding of pneumatic transportation in a constant stream (without formation of aggregates or lumps). Thus, such a powder allows fine control of the product/transportation air ratio, which ensures consistency of the transportation conditions in terms of stresses exerted on the powder and, consequently, avoids particle size fluctuations over time after transportation.

### EXAMPLE 3: SPECIFIC SURFACE AREA

The pulverulent sorbitol compositions PSC1 to PSC12 were analyzed to determine their specific surface areas according to the BET method (table 4). The specific surface areas are measured in accordance with the method described in the European Pharmacopoeia 6.0 N°01/2008:20926, page 306. The specific surface area is measured with a specific surface area analyzer (Micrometrics Gemini V, Sample Degas System Vac prep 061) based on a test of nitrogen absorption on the surface of the product subjected to the analysis, according to the technique described in the article “BET Surface Area by Nitrogen Absorption” by S. Brunauer et al. (Journal of American Chemical Society, 60, 309, 1938). The measurements are taken with a preliminary step of degassing under vacuum of the samples at 42° C. for 32 hours. As a guide, several commercial products are included in the same table.

TABLE 4
Specific surface areas of the various pulverulent compositions

| Composition | Specific surface area (m²/g) |
|---|---|
| PSC1 | 1.04 |
| PSC2 | 0.87 |
| PSC3 | 1.14 |
| PSC4 | 0.93 |
| PSC5 | 1.10 |
| PSC6 | 1.60 |
| PSC7 | 1.60 |
| PSC8 | 1.80 |
| PSC9 | 1.60 |
| PSC10 | 0.70 |
| PSC11 | 0.70 |
| PSC12 | 0.60 |

### EXAMPLE 4: MECHANICAL STABILITY

The pulverulent sorbitol compositions PSC1 to PSC5 were analyzed to determine their mechanical stabilities (table 5). As a guide, PSC4 and PSC5 are commercial products obtained via the pan agglomeration technology. Measurement of the mechanical stability consists in accelerating the particles of the pulverulent composition using an air jet and projecting it onto an inclined target at the end of the course. The impact speed, the inclination of the target and the powder feed rate are modifiable according to the operator's wishes. The schematic diagram of this machine is described in the article “Use of wet granulation powders: bases and theory” by S. Khashayar and P. Guigon (Techniques de l'Ingénieur Opérations Unitaires Tri et Traitement des Liquides et des Solides, [Engineering techniques unit operations: Sorting and treatment of liquids and solids], article ref.: j2253, 2014), URL=http://www.techniques-ingenieur.fr/base-documentaire/procedes-chimie-bio-agro-th2/operations-unitaires-tri-et-traitement-des-liquides-et-des-solides-42446210/mise-en-uvre-des-poudres-j2253/.

As a guide, the facility is formed:
from a continuous powder feed unit (vibrating hopper equipped with a system for monitoring the mass over time),
a pneumatic circuit for acceleration and transportation to the inclinable target. This circuit is constructed according to the principle described in the article “Experimental Investigations on Single Plate Fluid Energy Milling” by K. Lechsonski and U. Menzel (Proceedings of First World Conference on Particles Technology, Vol 2, 1988, 297-323),
an impact chamber equipped with an inclinable target and
a solid/gas separation system equipped with a filter.

The apparatus offers the possibility of passing the pulverulent composition several times through the circuit (several cycles).

The operating conditions used for comparing the various powders mentioned are identical to each other and are as follows:
feed rate of pulverulent composition: 1 g/sec,
air speed: 20 m/sec,
distance covered by the particles between the acceleration nozzle and the inclined target=1 m,
inside diameter of the tube connecting the acceleration nozzle and the inclined target=0.6 cm,
inclination of the target=45°,
shape, aspect and diameter of the inclined target=polished steel, circular, diameter 6 cm,
dimensions of the impact chamber=15×15×15 cm,
number of cycles=3.

The feed rate of the machine (pulverulent composition and air are controlled by computer). All the parts of the machine in contact with the product are connected to the ground to prevent absorption of powder via the electrostatic effect.

On conclusion of the three consecutive impact cycles, the pulverulent compositions are collected and analyzed by laser granulometry using a Mastersizer machine (model: Meyvis MZ63). The operating conditions are in accordance with the method described in the European Pharmacopoeia 6.0 N°01/2008:20931, page 311). In order to have the most reliable results possible, the powder is predispersed in sunflower oil (free of water). All the compositions mentioned in this patent were analyzed under identical conditions.

The mechanical stability index D(v,0.1) (MSI_{D(v,0.1)}), expressed as a percentage, represents the variation in D(v,0.1) when the pulverulent sorbitol composition is subjected to three consecutive impact cycles at 20 m/sec. For example, a powder having:

$$A D ( v , 0.1 ) before the impact test = 120 µm$$

$$A D ( v , 0.1 ) after the impact test ( three consecutive cycles at 20 m \text{/} sec ) = 46 µm . \\ The mechanical stability index ( M S I ) D ( v , 0.1 ) = \frac{( 120 - 46 ) \times 100}{120} = 61.6 \% .$$

The higher the MSI_{D(v,0.1)}, the more mechanically fragile the powder. D(v,0.1) is defined as being the maximum diameter of fine particles occupying 10% of the total volume of the powder.

TABLE 5
Measurement of the mechanical stability index of the powders

| | % of | % of | % of |
|---|---|---|---|
| | variation of | variation of | variation of |
| | D(v, 0.1): | D(v, 0.5): | D(v, 0.9): |
| Compositions | ISM_{D(v, 0.1)} | ISM_{Dv0.5} | ISM_{Dv0.9} |
| PSC1 | 48.9 | 16 | 11.78 |
| PSC2 | 47.8 | 14.5 | 8.73 |
| PSC3 | 52 | 15.5 | 8.46 |
| PSC4 | 71.4 | 26 | 18.34 |
| PSC5 | 69.3 | 22.1 | 13.68 |

The products according to the invention, namely PSC1 to PSC3, have a variation in D(v,0.1) of less than 53% following the impact test.

A marked difference of the order of 20% between the samples PSC1 to PSC3 and the samples PSC4 and PSC5 corresponding to the products of the prior art is noted.

In other words, the use of a product of the type PSC1 to PSC3 will have a tendency to create much fewer fines than products of PSC4 and PSC5 type during its pneumatic transportation, for example in production lines.

This stability of the powders according to the invention proves to be particularly advantageous for processes in which large shear forces are applied and/or a low variation in the content of fines or in the particle size distribution of the powder induces large consequences for the implementation of a process or for the qualities, especially the organoleptic qualities, of the finished product. Such is the case for chewing gum (CG) preparation processes.

### EXAMPLE 5 IMPROVEMENT OF ORGANOLEPTIC QUALITIES IN CG

The organoleptic evaluation of chewing gums containing sorbitol powders mentioned above was performed using the chewing gum evaluated method as described on pages 81 and 85 of the book “Formulation and Production of Chewing and Bubble Gum” (ISBN=0904725103).

The test chewing gum composition is represented in table 1:

TABLE 6
Chewing gum compositions.

| Chewing gum ingredients | Amount (g/100 g) |
|---|---|
| Sorbitol powder | 54.2 |
| Xylitol powder | 4.8 |
| Cafosa Geminis-T gum base | 30.7 |
| Maltitol powder | 3.3 |
| Maltitol syrup (solids: 80%) | 7.0 |
| Mane mint flavoring | qs |

Various sorbitol powders PSC13, PSC14 and PSC15 were obtained according to example 1. The various powders tested are referenced in table 7:

TABLE 7
Particle size distribution of the samples evaluated (100 ± 0.1).

| | <75 | 75-100 | 100-250 | 250-400 | 400-600 |
|---|---|---|---|---|---|
| Product | μm | μm | μm | μm | μm |
| Reference | 5.8 | 10.8 | 53.8 | 28.7 | 0.9 |
| PSC 13 | 0.5 | 4.7 | 51.1 | 42.8 | 0.9 |
| PSC 14 | 1.4 | 4.1 | 50.3 | 43.6 | 0.6 |
| Commercial | 6.9 | 10.4 | 49.7 | 26 | 7 |
| product | | | | | |
| PSC 15 | 0.8 | 3.1 | 44.3 | 50.5 | 1.4 |

Reference: Merisorb® 200 sold by Tereos Syral.

Commercial product: Neosorb P60W sold by Roquette Frères.

Analysis of the particle size distribution of the powders is performed using a Retsch sieve shaker, model AS200 control ‘g’ in accordance with the manufacturer's instructions. More particularly, in the following manner: 100 g of each of the powders are supplemented with 1 g of silica (Sipernat® 22S). The homogenized mass is screened with said equipment with an oscillation amplitude of 1.5 mm for 10 minutes. Each screen is then weighed so as to measure the weight of each of the particle size fractions and to calculate a percentage particle size distribution.

During the manufacture of the chewing gums, it was noted that, compared with the reference powder and the commercial powder, PSC13 and PSC14 allow a reduction in the mixing time of the composition in the chewing gum mixer. This constitutes an advantages for PSC13 and 14 according to the invention in comparison with all of the powders tested.

Once the chewing gums were obtained, the criteria relating to the appearance of the chewing gum (smooth surface without holes, well-defined edges) were evaluated. The results observed are similar for PSC13, PSC14 and PSC15, the reference powder and the commercial powder.

The sensory evaluation of the chewing gums was the subject of a strict protocol performed by a panel specifically trained for tasting chewing gums. The chewing gum tasting protocol is documented, and is more particularly described in “Formulation and production of chewing and bubble gum” by Douglas Fritz (Kennedys Books Ltd)—Hardcover (2008). This protocol is organized in three phases.

The initial phase corresponds to the attack on the palate during the first 10 seconds of tasting; the intermediate phase, up to three minutes, specifically describes the sensory properties of the chewing gum in terms of hydration, texture and aromatic perception since it is during this period that the majority of the flavorings and sweeteners are extracted from the matrix. The final phase, beyond three minutes, characterizes the degree of stability of the chewing gum properties over time, in terms of consistency and aromatic perception mainly.

The organoleptic parameters were evaluated by a trained panel, composed of nine people.

During the initial phase (first ten seconds), the force of attack, the cohesion, the speed of perception and the aromatic intensity are evaluated. During the intermediate phase (10 seconds to 3 minutes) the hydration (time taken by the matrix to absorb saliva), the cohesion, the texture, the tacky effect on the teeth, the aromatic power, the sweetness intensity and the refreshing power are evaluated. Finally, during the final phase (3 to 6 minutes), the hardness, the texture, the tackiness on the teeth, the size of the chewing gum in the mouth, the shape in the mouth (between two chews), the consistency, the width of the line when the chewing gum is stretched, the aromatic power, the sweetness intensity and, finally, the refreshing power are evaluated. The evaluation system uses a five-point system corresponding to five grades or scores for each of the descriptors. All of the parameters defined above were tested (initial phase, intermediate phase and final phase). The scores and all of the parameters tested are described in the above reference.

During its analysis, the panel noted that, among all of the parameters measured, many parameters were maintained by the use of the screened products in comparison with the reference powders and the commercial powder.

Only the parameters for which a difference is observed are detailed below. The scores for the parameters tested are defined in the system as below (Table 8).

In table 8, P1 corresponds to the initial phase (first 10 seconds), and P2 to the intermediate phase (between 10 seconds and 3 minutes):

TABLE 8
Scores of the parameters tested

| | Score | 1 | 2 | 3 | 4 | 5 |
|---|---|---|---|---|---|---|
| P1 | Force of attack | Firm | | Normal | | Soft |
| P2 | Texture | Granular | | | | Smooth |
| P2 | Aromatic power | Lack of | | Normal | | Burns the |
| | | flavor | | | | tongue |
| P2 | Sweetness intensity | Little | | Normal | | Substantial |
| P2 | Refreshing power | Little | | Normal | | Substantial |

The modified values obtained by the trained panel are given in table 9.

TABLE 9
Organoleptic evaluation

| | | | | Commercial | |
|---|---|---|---|---|---|
| | Reference | PSC13 | PSC14 | product | PSC15 |
| Force of attack | 3.1 | 2.3 | 2.4 | 3.7 | 2.4 |
| Texture | 3.2 | 3.5 | 3.5 | 3.0 | 2.7 |
| Aromatic power | 3.6 | 4.3 | 4.0 | 3.7 | 2.5 |
| Sweetness | 3.0 | 3.3 | 3.4 | 3.2 | 2.9 |
| intensity | | | | | |
| Refreshing effect | 3.3 | 4.0 | 3.7 | 3.4 | 2.5 |

In the case of products PSC13, PSC14 and PSC15, a marked increase in the force of attack is observed, in the initial phase (first 10 seconds), when compared with the reference powder and the commercial powder.

In the intermediate phase (between 10 seconds and 3 minutes) an intensification of the aromatic power, of the sweetness intensity and of the refreshing effect is observed for the products PSC13 and PSC14 but not for PSC15 in comparison with the reference powder and the commercial powder. The effect of the particle distribution, as described in table 7, is clear and pronounced.

However, there is a limit to this screening process. In the case where the product is excessively screened, as in the case of PSC15, the force of attack remains identical, but the aromatic perception and the refreshing effect are clearly negatively affected when compared with PSC13 and PSC14, but even more so when compared with the reference and also with the commercial product.

Thus, PSC13 and PSC14 are particularly advantageous in that the improvement in the aromatic power of the chewing gum by using these powders makes it possible, for the same amount of sorbitol in the chewing gum, to reduce the amount of flavoring to obtain an identical aromatic perception.

PSC13 and PSC14 also make it possible to perceive a greater sweetness effect and also a greater refreshing effect than the reference and commercial sorbitols, which makes it possible to intensify the taste of the chewing gum obtained.

The effect of the particle size distribution of the sorbitol powders on the aromatic perception, the sweetness intensity and the refreshing effect of the chewing gum obtained is thus demonstrated for the first time.

It will also be noted that the variation in particle size distribution of PSC15, in addition to reducing the aromatic power, the sweetness intensity and the refreshing effect of the known sorbitols, also induces a granular structure of the chewing gum, which is not desired since this sensation is unpleasant on the tongue.

This test also shows that the reduction in fine particles does, admittedly, improve the organoleptic properties of the chewing gum, but that this reduction in fines must satisfy certain criteria. In other words, the sorbitol powder must not be excessively de-fined in order for the improvement of the organoleptic properties of the chewing gum to be observed.

Thus, a very fine difference in particle size of the sorbitol powder leads to detectable effects on the final chewing gum as regards the granular nature of the chewing gum in the mouth or the aromatic perception, the sweetness intensity or the refreshing effect (PSC13 or PSC14 versus PSC15).

More specifically, the present example demonstrates that the powder according to the invention makes it possible, in comparison with the commercial sorbitol powders, i) to reduce the mixing times to obtain the chewing gums in comparison with the reference products, ii) to obtain a chewing gum having an improved force of attack, texture, aromatic power, sweetness intensity and refreshing effect, iii) while at the same time maintaining the properties of the chewing gum such as the cohesion, the speed of perception, the hydration, the texture, the tacky effect or the consistency.

1. A pulverulent composition having
at least 96% sorbitol (w/w) as solids,
a sorbitol/(mannitol+arabitol) (w/w) ratio A of between 105 and 150,
and/or
a mechanical stability index D(v,0.1) (MSI_{D(v,0.1)}) of less than 60%, the MSI_{D(v,0.1)} being equal to:
$$M S {I}_{D ( v , 0.1 )} = \frac{( D ( v , 0.1 ) a - D ( v , 0.1 ) b ) \times 100}{D ( v , 0.1 ) a}$$
in which D(v,0.1)b corresponds to the D(v,0.1) of said pulverulent composition measured after an impact test comprising three cycles of projection of said pulverulent composition at 20 m/sec onto a non-deformable smooth surface, and D(v,0.1)a corresponds to the D(v,0.1) of said pulverulent composition measured before the impact test,
a bulk density of from 630 to 700 g/l.

2. The pulverulent composition as claimed in claim 1, characterized in that it has a tapped density of from 650 to 730 g/l.

3. The pulverulent composition as claimed in claim 1, characterized in that it has a ratio A of between 110 and 145.

4. The pulverulent composition as claimed in claim 1, characterized in that it has a mean particle size of from 100 to 400 microns.

5. The pulverulent composition as claimed in claim 1, characterized in that it is composed of crystal agglomerates.

6. The pulverulent composition as claimed in claim 1, characterized in that it has a particle size distribution, determined by particle size analysis, using Retsch equipment, as follows:
from 0 to 2.3% by weight of particles >400 microns,
from 34.8% to 54.9% by weight of particles between 250 and 400 microns,
from 42.7% to 57.9% by weight of particles between 100 and 250 microns,
from 1.4% to 8.0% by weight of particles between 75 and 100 microns, and
from 0.5 to 4.8% by weight of particles <75 microns, the sum of the various fractions of which being 100% by weight.

7. The pulverulent composition as claimed in claim 1, characterized in that it has a particle size distribution, determined by particle size analysis, using Retsch equipment, as follows:
from 0 to 1% by weight of particles >400 microns,
from 40% to 45% by weight of particles between 250 and 400 microns,
from 48% to 53% by weight of particles between 100 and 250 microns,
from 3.5% to 8% by weight of particles between 75 and 100 microns, and
from 0.5% to 2.5% by weight of particles <75 microns, the sum of the various fractions of which being 100% by weight.

8. A process for preparing a pulverulent composition as claimed in claim 1, characterized in that it comprises:
a step of crystallizing a sorbitol syrup comprising a sorbitol/(mannitol+arabitol) ratio A of between 105 and 150,
a step of wet granulation of the powder obtained using a binder;
a step of maturation, by drying, of the granulated composition thus obtained.

9. The preparation process as claimed in claim 8, characterized in that the crystallization and/or granulation step is performed in a continuous mixer-granulator, an extruder, an atomization tower or by pan agglomeration.

10. The preparation process as claimed in claim 9, characterized in that said sorbitol syrup used during the crystallization and/or granulation step has a solids content of between 65% and 99.9%.

11. A chewing gum, characterized in that it comprises 2% to 85% (w/w) of a pulverulent composition as claimed in claim 1.

12. A method for producing a chewing gum, comprising the following steps consisting in:
obtaining a base gum
mixing the base gum with a pulverulent composition as claimed in claim 1.

13. The pulverulent composition as claimed in claim 1, characterized in that it has a sorbitol/(mannitol+arabitol) (w/w) ratio A of between 110 and 149.

14. The pulverulent composition as claimed in claim 1, characterized in that it has a mechanical stability index D(v,0.1) (MSI_{D(v,0.1)}) of less than 55%.

15. The pulverulent composition as claimed in claim 1, characterized in that it has a specific surface area of between 0.6 and 1.8 m²/g.

16. The preparation process as claimed in claim 8, characterized in that the sorbitol syrup comprises a sorbitol/(mannitol+arabitol) ratio A of between 110 and 145.

17. The preparation process as claimed in claim 8, characterized in that the binder is a sorbitol syrup comprising a sorbitol/(mannitol+arabitol) ratio A of between 105 and 150.

18. The preparation process as claimed in claim 8, further comprising a step of cooling of the granulated composition obtained at a temperature below 10° C.

19. The preparation process as claimed in claim 10, characterized in that said sorbitol syrup used during the crystallization and/or granulation step has a solids content of between 70% and 99.8%.

20. The method for producing a chewing gum as claimed in claim 12, further comprising adding any one of the elements chosen from a plasticizer, a filler, a flavoring and a mixture thereof.
